(19) United States
(12) Patent Application Publication
(10) Pub. No.: US 2023/0047573 A1
(43) Pub. Date: Feb. 16, 2023

(54) HAIRBALL REMEDY PASTE FOR CATS

(71) Applicant: Shenzhen Redray Biotechnology Corp., Ltd., Shenzhen (CN)

(72) Inventors: Ruili LIU, Shenzhen (CN); Minhong LI, Shenzhen (CN); Yueqi ZHENG, Shenzhen (CN); Junjun WANG, Shenzhen (CN)

(21) Appl. No.: 17/505,644

(22) Filed: Oct. 20, 2021

(30) Foreign Application Priority Data
Aug. 4, 2021 (CN) 202110889644.0

(51) Int. Cl. A23K 50/45; A23K 10/20; A23K 20/163; A23K 20/22; A23K 20/121; A23K 20/174; A23K 10/30; A23K 20/20; A23K 20/105; A23K 20/158

(52) U.S. Cl. CPC A23K 50/45; A23K 10/20; A23K 20/163; A23K 20/22; A23K 20/121; A23K 20/174; A23K 10/30; A23K 20/30; A23K 20/105; A23K 20/158

(57) ABSTRACT

The present disclosure provides a hairball remedy paste for cats, including collagen, sodium carboxymethylcellulose, bone glue, chicken liver powder, chicken meal, edible oil, fructooligosaccharide, hydrolyzed fish protein powder, maltitol, Saccharomyces cerevisiae extract, glycerol, barley seedling powder, vitamin nano-liposomes, protein chelated mineral, potassium iodide, taurine, and water. The hairball remedy paste for cats does not contain mineral oil, and does not affect the absorption of nutrient substances by intestines and stomach after long-term use. Through the synergistic effect of edible oil, fructooligosaccharide, and barley seedling powder, it is conducive to help cats to discharge hairs in intestines and stomach through feces, which can effectively prevent the occurrence of the trichobezoar and improve the constipation of cats.

### CROSS REFERENCE TO RELATED APPLICATIONS

The present disclosure claims priority to Chinese Patent Application No. 202110889644.0, filed Aug. 4, 2021, which is hereby incorporated by reference herein as if set forth in its entirety.

### BACKGROUND

### 1. Technical Field

The present disclosure relates to the field of pet foods, and particularly to a hairball remedy paste for cats.

### 2. Description of Related Art

In recent years, feeding pets has become a current fashion trend, and the status of pets in every family has become more and more important. Cats have become pets widely fed worldwide as animals domesticated by human for 3500 years, so people now attach more and more importance to the health of cats. As is well known, cats are animals which love cleanness and tidiness, licking hair has become a life instinct of cats, and licking hair is performed in almost half of the time except sleeping in one day. Licking hair can play a role in relieving stress, preserving heat, dissipating heat, removing dirt, waste hair, and metabolized dander cells on the body, reducing odor, so as to avoid tracking natural enemies and the like. However, in the process of licking hair, barbs on the tongue of the cat can roll the shed hair into the digestive tract, and the hair is not easy to digest, so the hair can be accumulated in the intestines and the stomach and gradually gathered into hairballs. When the hairballs are large to a certain extent to hinder the normal activities of the animal and cause various diseases (such as intestine and stomach diseases such as intestinal infarction, intussusception, and the like), this disease is called as trichobezoar. When the hairballs are accumulated to a certain extent, if the hair cannot be discharged through feces, the cat will frequently vomit the hairballs. However, if the hairballs are vomited out, the cat can easily suffer from chronic gastrointestinal diseases due to long-term and irregular gastric acid reflux. Once a cat suffers from the chronic gastrointestinal diseases, nutrient substances cannot be normally absorbed and utilized by the digestive system of the cat, and the immunity of the cat can be reduced due to the lack of the nutrient substances, so that the cat can easily suffer from diseases which are commonly suffered by pets of people.

The trichobezoar usually occurs in the spring and autumn seasons for replacement of hair, at this case the cats lick hairs more frequently, eat more hairs than usual, and are more prone to suffer from the disease. Symptoms of trichobezoar include: (1) frequently retching (particularly shortly after eating food); (2) sometimes vomiting some cylindrical hairballs with mucus adhered to the surface thereof, but sometimes vomiting nothing out; (3) the feces being dry and hard with hairs therein; and (4) in severe cases, poor mental condition, poor appetite, rough and dull hair, constipation accompanied by abdominal distension.

In order to prevent or treat the trichobezoar, and to help cats to discharge hairs from the body, it is necessary to regularly feed the cats with a hairball remedy paste. However, the main active ingredient of the conventional hairball remedy paste is mineral oil. Although the mineral oil can play a role in lubrication and promote the cats to discharge hair in intestines and stomach through feces, the mineral oil is not absorbed and digested in the intestines and stomach and can bring out all lipid-soluble vitamins in organisms, so that the lipid-soluble vitamins cannot be absorbed by the organisms. Long term use of the mineral oil may affect the absorption of the intestines and stomachs on nutrient substances, which seriously endangers the health of the cats.

### DETAILED DESCRIPTION

In order to make the objectives, technical solutions, and advantages of the present disclosure clearer, the present disclosure will be further described in detail below with reference to the embodiments. It should be understood that, the embodiments described herein are only for explaining the present disclosure and are not intended to limit the present disclosure.

Preparation

### EXAMPLE 1

Ingredients included: 0.1 KG of collagen; 2.5 KG of sodium carboxymethylcellulose; 2 KG of bone gelatin; 5 KG of chicken liver powders; 3.5 KG of chicken meal; 10 KG of sesame oil; 1 KG of fish oil; 10 KG of fructooligosaccharide; 0.9 KG of hydrolyzed fish protein powders; 8 KG of maltitol; 5 KG of Saccharomyces cerevisiae extracts; 1 KG of glycerol; 0.8 KG of barley seedling powders; 4 KG of vitamin nano-liposomes; 0.1 KG of protein iron; 0.01 KG of protein copper; 0.02 KG of protein manganese; 0.1 KG of protein zinc; 0.001 KG of potassium iodide; 0.2 KG of taurine; and 46.5 KG of water.

Ingredients of the vitamin nano-liposome included: 0.05 KG of vitamin A; 0.005 KG of vitamin D3; 0.15 KG of vitamin E; 0.015 KG of vitamin Bl; 0.015 KG of vitamin B2; 0.015 KG of D-calcium pantothenate; 0.1 KG of niacin; 0.007 KG of vitamin B6; 0.007 KG of folic acid; 0.015 KG of vitamin B12; 1.8 KG of lecithin; 0.75 KG of cholesterol; and 1.071 KG of Tween 80.

Preparation Method

At S1, materials other than the vitamin nano-liposomes were added into a steam-heated emulsification stirring tank with an emulsification stirring speed of 1500 r/min to 2500 r/min and a slow stirring speed of 20 r/min to 30 r/min. The emulsification stirring and the slow stirring were carried out simultaneously for 30 minutes to obtain a first mixture.

At S2, a steam inlet switch of the steam-heated emulsification stirring tank was turned on, and the first mixture was heated to 100° C. by steam while stirring to obtain a second mixture.

At S3, the vitamin nano-liposomes were added when the second mixture was cooled to 85±2° C., stirred uniformly, and then canned, to obtain the hairball remedy paste for cats.

### EXAMPLE 2

Ingredients included: 0.5 KG of collagen; 0.8 KG of sodium carboxymethylcellulose; 5 KG of bone gelatin; 3 KG of chicken liver powders; 5 KG of chicken meal; 4 KG of sesame oil; 6 KG of fish oil; 4 KG of fructooligosaccharide; 0.5 KG of hydrolyzed fish protein powders; 20 KG of maltitol; 1 KG of Saccharomyces cerevisiae extracts; 0.5 KG of glycerol; 0.1 KG of barley seedling powders; 3 KG of vitamin nano-liposomes; 0.5 KG of protein iron; 0.07 KG of protein copper; 0.08 KG of protein manganese; 0.35 KG of protein zinc; 0.005 KG of potassium iodide; 0.75 KG of taurine; and 45.1 KG of water.

Ingredients of the vitamin nano-liposome included: 0.01 KG of vitamin A; 0.001 KG of vitamin D3; 0.08 KG of vitamin E; 0.005 KG of vitamin Bl; 0.005 KG of vitamin B2; 0.005 KG of D-calcium pantothenate; 0.01 KG of niacin; 0.0015 KG of vitamin B6; 0.0015 KG of folic acid; 0.005 KG of vitamin B12; 1.926 KG of lecithin; 0.2 KG of cholesterol; and 0.75 KG of Tween 80.

Preparation Method

At S1, materials other than the vitamin nano-liposomes were added into a steam-heated emulsification stirring tank with an emulsification stirring speed of 1500 r/min to 2500 r/min and a slow stirring speed of 20 r/min to 30 r/min. The emulsification stirring and the slow stirring were carried out simultaneously for 30 minutes to obtain a first mixture.

At S2, a steam inlet switch of the steam-heated emulsification stirring tank was turned on, and the first mixture was heated to 100° C. by steam while stirring to obtain a second mixture.

At S3, the vitamin nano-liposomes were added when the second mixture was cooled to 85±2° C., stirred uniformly, and then canned, to obtain the hairball remedy paste for cats.

Efficacy Evaluation Test

1. Test Animals

Forty cats with good health conditions and close hair amount and hair length were selected as study objects, and the forty cats had never eaten hair discharging products before the study. Each cat was kept in a single cage with independent space for activity and free drinking water. The cats were fed for 3 days under the same condition before formal tests.

2. Grouping

The forty cats were randomly divided into 2 groups, each with twenty cats, which were a test group and a negative control group, as shown in Table 1 below:

TABLE 1
Grouping

| | | Serial | | |
|---|---|---|---|---|
| Group | Number | Number | Breed | Age |
| Test | 1 | A1 | British Shorthair | Adult |
| Group | | | Blue Cat | |
| | 2 | A2 | British Shorthair | Adult |
| | | | Blue Cat | |
| | 3 | A3 | British Shorthair | Adult |
| | | | Blue Cat | |
| | 4 | A4 | Pastoral Cat | Adult |
| | 5 | A5 | Pastoral Cat | Adult |
| | 6 | A6 | British Shorthair | Adult |
| | | | Blue Cat | |
| | 7 | A7 | British Shorthair | Adult |
| | | | Blue Cat | |
| | 8 | A8 | British Shorthair | Adult |
| | | | Blue Cat | |
| | 9 | A9 | Pastoral Cat | Adult |
| | 10 | A10 | Pastoral Cat | Adult |
| | 11 | A11 | Pastoral Cat | Adult |
| | 12 | A12 | Pastoral Cat | Adult |
| | 13 | A13 | British Shorthair | Adult |
| | | | Blue Cat | |
| | 14 | A14 | British Shorthair | Adult |
| | | | Blue Cat | |
| | 15 | A15 | British Shorthair | Adult |
| | | | Blue Cat | |
| | 16 | A16 | British Shorthair | Adult |
| | | | Blue Cat | |
| | 17 | A17 | British Shorthair | Adult |
| | | | Blue Cat | |
| | 18 | A18 | British Shorthair | Adult |
| | | | Blue Cat | |
| | 19 | A19 | Pastoral Cat | Adult |
| | 20 | A20 | Pastoral Cat | Adult |
| Negative | 1 | B1 | Pastoral Cat | Adult |
| Control | 2 | B2 | Pastoral Cat | Adult |
| Group | 3 | B3 | British Shorthair | Adult |
| | | | Blue Cat | |
| | 4 | B4 | British Shorthair | Adult |
| | | | Blue Cat | |
| | 5 | B5 | British Shorthair | Adult |
| | | | Blue Cat | |
| | 6 | B6 | Pastoral Cat | Adult |
| | 7 | B7 | Pastoral Cat | Adult |
| | 8 | B8 | British Shorthair | Adult |
| | | | Blue Cat | |
| | 9 | B9 | British Shorthair | Adult |
| | | | Blue Cat | |
| | 10 | B10 | British Shorthair | Adult |
| | | | Blue Cat | |
| | 11 | B11 | British Shorthair | Adult |
| | | | Blue Cat | |
| | 12 | B12 | British Shorthair | Adult |
| | | | Blue Cat | |
| | 13 | B13 | British Shorthair | Adult |
| | | | Blue Cat | |
| | 14 | B14 | Pastoral Cat | Adult |
| | 15 | B15 | Pastoral Cat | Adult |
| | 16 | B16 | British Shorthair | Adult |
| | | | Blue Cat | |
| | 17 | B17 | British Shorthair | Adult |
| | | | Blue Cat | |
| | 18 | B18 | British Shorthair | Adult |
| | | | Blue Cat | |
| | 19 | B19 | Pastoral Cat | Adult |
| | 20 | B20 | Pastoral Cat | Adult |

3. Test Method

(1) The test time was 28 days. (2) Twenty cats in the test group were fed the same dosage of the hairball remedy paste for cats according to Example 1 at the same time, at a dosage of 4 g per day. (3) Twenty cats in the negative control group were not fed any hair discharging products. (4) Index observations were made and recorded for forty cats per day, and the conditions of vomiting hair, the amount of hair in feces, mental status, food intake, and feces of each cat were recorded.

4. Test Results

4.1 Changes in Mental Status and Food Intake During the Test

The mental status and food intake of all cats were normal from day 1 to day 28 of the test.

4.2 Comparison of Hair Discharging Effects

The conditions of vomiting hair and the feces containing hair of the forty cats were recorded daily during the test, and statistical data for the conditions of vomiting hair and the feces containing hair of the cats over the 28 days of the test were obtained. The first two days of the test were pre-tests, and the recorded data were not stable, so that the above statistics of the data were counted from the third day of the test.

4.2.1 Statistics of Vomiting Hair Recorded in Test

The twenty cats in the test group had no abnormal vomiting during the test. The cats in the negative control group had vomiting on day 5 and day 10, at a total of 12 cats, and the vomit was observed and analyzed to find that the vomit did not contain hairballs.

4.2.2 Comparison of the Amount of Hair Discharging During the Test

The hair discharging data of the forty cats from day 3 to day 28 for 26 days during the test were counted according to feces to obtain comparison of the number of days without hair discharging, the number of days with less hair discharging, and the number of days with more hair discharging for each cat, as shown in the following Tables 2 to 4:

TABLE 2
Statistics of the number of days corresponding
to the amount of hair discharging

| | | | The number of days of hair | | |
|---|---|---|---|---|---|
| | | | discharging (Day) | | |
| | | | Without | Less | More |
| | | Serial | hair | hair | hair |
| Group | Number | Number | discharging | discharging | discharging |
| Test | 1 | A1 | 12 | 6 | 8 |
| Group | 2 | A2 | 7 | 11 | 8 |
| | 3 | A3 | 9 | 11 | 6 |
| | 4 | A4 | 19 | 5 | 2 |
| | 5 | A5 | 15 | 7 | 4 |
| | 6 | A6 | 13 | 6 | 7 |
| | 7 | A7 | 14 | 4 | 8 |
| | 8 | A8 | 12 | 6 | 8 |
| | 9 | A9 | 9 | 11 | 6 |
| | 10 | A10 | 11 | 10 | 5 |
| | 11 | A11 | 14 | 7 | 5 |
| | 12 | A12 | 8 | 14 | 4 |
| | 13 | A13 | 7 | 9 | 10 |
| | 14 | A14 | 6 | 11 | 9 |
| | 15 | A15 | 7 | 11 | 8 |
| | 16 | A16 | 13 | 7 | 6 |
| | 17 | A17 | 15 | 4 | 7 |
| | 18 | A18 | 14 | 4 | 8 |
| | 19 | A19 | 10 | 10 | 6 |
| | 20 | A20 | 8 | 12 | 6 |
| Negative | 1 | B1 | 25 | 0 | 1 |
| Control | 2 | B2 | 24 | 1 | 1 |
| Group | 3 | B3 | 25 | 1 | 0 |
| | 4 | B4 | 25 | 0 | 1 |
| | 5 | B5 | 25 | 1 | 0 |
| | 6 | B6 | 24 | 2 | 0 |
| | 7 | B7 | 25 | 1 | 0 |
| | 8 | B8 | 26 | 0 | 0 |
| | 9 | B9 | 24 | 2 | 0 |
| | 10 | B10 | 25 | 1 | 0 |
| | 11 | B11 | 26 | 0 | 0 |
| | 12 | B12 | 24 | 2 | 0 |
| | 13 | B13 | 24 | 2 | 0 |
| | 14 | B14 | 26 | 0 | 0 |
| | 15 | B15 | 25 | 1 | 0 |
| | 16 | B16 | 25 | 1 | 0 |
| | 17 | B17 | 24 | 2 | 0 |
| | 18 | B18 | 26 | 0 | 0 |
| | 19 | B19 | 24 | 2 | 0 |
| | 20 | B20 | 23 | 3 | 0 |

TABLE 3
Comparison of the number of days corresponding to
the amount of hair discharging between groups

| | The number of days of hair | | |
|---|---|---|---|
| | discharging (Day) | | |
| | Without | Less | More |
| | hair | hair | hair |
| Group | discharging | discharging | discharging |
| Test Group | 223 | 166 | 131 |
| Negative | 495 | 22 | 3 |
| Control Group | | | |

TABLE 4
Comparison of proportion of the number of days corresponding
to the amount of hair discharging between groups

| | Proportion of the number of | | |
|---|---|---|---|
| | days of hair discharging | | |
| | Without | Less | More |
| | hair | hair | hair |
| Group | discharging | discharging | discharging |
| Test Group | 42.88% | 31.92% | 25.19% |
| Negative | 95.19% | 4.23% | 0.58% |
| Control Group | | | |

As can be seen from Tables 2 to 4, the test group had the most number of days of hair discharging (297/520), accounting for 57.11%, and the number of days corresponding to more hair discharging contained in feces was also the most (131/520), accounting for 25.19%. The negative control group had the least number of days of hair discharging (25/520), accounting for 4.8%, and the number of days corresponding to more hair discharging contained in feces was also the least (3/520), accounting for 0.58%.

4.2.3 Comparison of Duration of Hair Discharging During the Test

During the test, statistics on the amount of hair discharging of the forty cats from day 3 to day 28 were calculated based on the feces, and a comparison of duration of hair discharging was obtained, as shown in Table 5 below:

TABLE 5
Longest duration of hair discharging

| | Longest duration of feces |
|---|---|
| Group | containing hair discharging (Day) |
| Test Group | 20 |
| | 3 |
| Negative | (Days of normal physiological |
| Control Group | defecation containing hair discharging) |

4.2.4 Comparison of Feces Grade During Test

The feces of the forty cats was observed from day 3 to day 28 during the test. Referring to Table 6 below, the feces produced by cats in both the test group and the negative control group were normal, and the feces were substantially stable at grade 2 to grade 3.

TABLE 6
Cat feces grading standard

Grade 1: hard and dry, generally agglomerated, not easily discharged from
the body and leaving no residue during discharging.
Grade 2: firm but not hard, easy to bend, segmented in appearance, with
little or no residue left during discharging.
Grade 3: long strip, with few or no segments, moist surface, and retaining
the original shape but having residues during discharging.
Grade 4: long strip, very moist, wet feces, cannot retain the original
shape and having residues during discharging.
Grade 5: very moist but still having a clear outline, stacked, cannot
retain the original shape and having residues during discharging.
Grade 6: unable to be formed but unsmooth surface, stacked or dripped,
having residues during discharging.
Grade 7: watery, without shape

4.3 Summary

1. The hairball remedy paste for cats uses edible oil, fructooligosaccharide, and barley seedling powder in combination, has a synergistic effect, does not contain mineral oil, and does not affect the absorption of nutrient substances by intestines and stomach after long-term use. The edible oil can reduce gastrointestinal friction and promote gastrointestinal peristalsis. The fructooligosaccharide can regulate intestines and stomach and promote gastrointestinal peristalsis. The fructooligosaccharide cannot be absorbed in the stomach and small intestine, and can drive hair in the stomach and small intestine to be combined with feces. Nutritional ingredient contained in the barley seedling powder having the highest content is insoluble dietary fiber. The content of the insoluble dietary fiber is as high as 34.4% to 39.1%. The insoluble dietary fiber can reduce the pH value of intestines and stomach, and has high water holding capacity. The insoluble dietary fiber with high water holding capacity is in a form of a paste in the intestines and stomach, and can adhere to hair in the intestines and stomach to form gel balls, which may in turn stimulate the intestines and stomach, promote organisms to defecate, and shorten the running time of intestines and stomach. Through the synergistic effect of edible oil, fructooligosaccharide, and barley seedling powder, it is conducive to help cats to discharge hairs in intestines and stomach through feces, which can effectively prevent the occurrence of the trichobezoar and improve the constipation of cats.

2. The hairball remedy paste for cats contains vitamin nano-liposomes and protein chelated minerals. The vitamin nano-liposomes can avoid serious degradation of vitamins during high-temperature and high-pressure processing, can ensure the stability of the vitamins during processing and during in vivo digestion and absorption, and can meet the demand of cats for the vitamins. The vitamin nano-liposomes and the protein chelated minerals can ensure the normal metabolic process of an organism, achieve the effect of total nutrition supplement, and avoid affecting the normal defecation function of the organism due to the lack of vitamins and minerals, thereby affecting the hair discharging effect.

3. The hairball remedy paste for cats can help cats to discharge hairs in intestines and stomach, which is completely achieved by discharging hairs in intestines and stomach through feces. The hairs are not discharged by means of vomiting, so that the health of the digestive system of the cats is not affected.

The above-mentioned embodiments are merely intended for describing but not for limiting the technical schemes of the present disclosure. Although the present disclosure is described in detail with reference to the above-mentioned embodiments, it should be understood by those skilled in the art that, the technical schemes in each of the above-mentioned embodiments may still be modified, or some of the technical features may be equivalently replaced, while these modifications or replacements do not make the essence of the corresponding technical schemes depart from the spirit and scope of the technical schemes of each of the embodiments of the present disclosure, and should be included within the scope of the present disclosure.

What is claimed is:

1. A hairball remedy paste for cats, by mass percentage, comprising the following raw materials: 0.1% to 0.5% of collagen; 0.8% to 2.5% of sodium carboxymethylcellulose; 1% to 5% of bone glue; 3% to 5% of chicken liver powder; 3% to 5% of chicken meal; 5% to 16% of edible oil; 4% to 10% of fructooligosaccharide; 0.5% to 0.9% of hydrolyzed fish protein powder; 8% to 20% of maltitol; 1% to 5% of Saccharomyces cerevisiae extract; 0.5% to 1% of glycerol; 0.1% to 0.8% of barley seedling powder; 3% to 4% of vitamin nano-liposomes; 0.23% to 1% of protein chelated mineral; 0.001% to 0.005% of potassium iodide; 0.2% to 0.75% of taurine; and 30.1% to 50.5% of water; wherein a sum of the mass percentages of the raw materials is 100%.

2. The hairball remedy paste for cats of claim 1, wherein the vitamin nano-liposome comprises vitamin A, vitamin D3, vitamin E, vitamin B1, vitamin B2, D-calcium pantothenate, niacin, vitamin B6, folic acid, vitamin B12, lecithin, cholesterol, and Tween 80.

3. The hairball remedy paste for cats of claim 2, wherein by mass percentage, in the hairball remedy paste for cats, the vitamin A has a content of 0.01% to 0.05%, the vitamin D3 has a content of 0.001% to 0.005%, the vitamin E has a content of 0.08% to 0.15%, the vitamin B1 has a content of 0.005% to 0.015%, the vitamin B2 has a content of 0.005% to 0.015%, the D-calcium pantothenate has a content of 0.005% to 0.015%, the niacin has a content of 0.01% to 0.1%, the vitamin B6 has a content of 0.0015% to 0.007%, the folic acid has a content of 0.0015% to 0.007%, the vitamin B12 has a content of 0.005% to 0.015%, the lecithin has a content of 1.8% to 2.4%, the cholesterol has a content of 0.2% to 0.75%, and the Tween 80 has a content of 0.75% to 1.35%.

4. The hairball remedy paste for cats of claim 1, wherein the protein chelated mineral comprises protein iron, protein copper, protein manganese, and protein zinc.

5. The hairball remedy paste for cats of claim 4, wherein by mass percentage, in the hairball remedy paste for cats, the protein iron has a content of 0.1% to 0.5%, the protein copper has a content of 0.01% to 0.07%, the protein manganese has a content of 0.02% to 0.08%, and the protein zinc has a content of 0.1% to 0.35%.

6. The hairball remedy paste for cats of claim 1, wherein the edible oil is one or more selected from the consisting of chicken oil, fish oil, corn germ oil, olive oil, walnut kernel oil, safflower seed oil, sunflower seed oil, linseed oil, evening primrose seed oil, and sea buckthorn seed oil.
